(19) United States
(12) Patent Application Publication
(10) Pub. No.: US 2012/0160887 A1
(43) Pub. Date: Jun. 28, 2012

(54) DISPLAY SLEEVE FOR PARKING TICKETS AND THE LIKE

(76) Inventor: Sung Chung, Toronto (CA)

(21) Appl. No.: 13/046,271

(22) Filed: Mar. 11, 2011

(30) Foreign Application Priority Data
Mar. 11, 2010 (CA) 2696265

(51) Int. Cl. B60R 11/00; B65D 27/00

(52) U.S. Cl. 224/482; 229/67.1

(57) ABSTRACT

A sleeve for holding and display a document is provided and a method of using the sleeve is described. The sleeve can include a back wall having a top, two opposing sides and a bottom. The sleeve can be attached to a window of a vehicle so that an open-topped receptacle suitable for receiving documents is formed by the back wall, sides walls, bottom wall and the window. Document can be inserted into the receptacle with information on the document facing towards the window so that the information can be read from outside the vehicle.

### BACKGROUND

This invention is in the field of display sleeves, and more specifically to such sleeves which are used for receiving and displaying parking receipts and the like.

There are many types of documents that are required to be displayed in vehicle windshields. Such documents include government-issued parking permits for handicapped or disabled persons, for specific residential or business areas, and for people providing certain services such as commercial, delivery, messenger, maintenance, angle loading, and media services. Private companies also often require windshield display of documents, including permits or stubs for privately-owned parking spaces, parking lots, business parking, and residential complexes. These documents are required to be displayed such that the permit number or bar code, date, and time are easily readable from the outside of the vehicle. It is desirable to have a device and method of accomplishing this quickly and easily.

Oftentimes documents such as parking receipts or stubs are required to be placed on the driver's side dashboard within three inches of the windshield so that they can be easily spotted and are easily viewable by parking attendants and officers. However, these tickets and stubs tend to be light and flimsy and can thus be easily blown off the dashboard or be turned over by a slight breeze, including the breeze created when closing the vehicle door. This can require a person to have to reopen their vehicle door and replace the ticket in the correct place, then close the door in a very gentle manner so as to not disturb the ticket sitting on the dashboard. Alternatively, a person may not even realize that the ticket stub had been disturbed, and may simply walk away from their car. This situation exposes that person to the risk of receiving and having to pay for a parking citation for failing to properly display their parking stub in the prescribed manner.

Parking stubs are sometimes valid for only a short period of time, or can be used for multiple days, or even weeks. When parking stubs are used for only a single parking transaction on a frequent basis, these stubs can pile up, cluttering up the dashboard. This can make it difficult for a parking officer to identify the most current parking stub out of a clutter of stubs, leading to issuance of a parking citation. These old stubs can also slide off of the dashboard with a slight breeze or while the vehicle is in motion, littering the car with old parking stubs. When parking stubs are valid for multiple uses on multiple days, it is easy for parking stubs to get lost. The parking stub can slide off of the dashboard onto the ground and get blown under vehicle seats or could be mistaken for an old parking stub and be accidentally thrown away.

Documents such as parking permits are often of the type that hang off of an interior rearview mirror of a vehicle such that the necessary information is easily findable and viewable for a parking attendant. However, not all vehicles come equipped with an interior rear view mirror (for example, large trucks), leaving no place to hang a parking permit. Other vehicles have rear view mirrors with attachment posts that are too thick to accommodate clips or the catch of hang tag parking permits. This leaves the problem of where and how to display the parking permit without losing it in the vehicle while the car is in motion.

Some of the problems associated with displaying parking permits and stubs have been addressed by the placement of placard holders on the dashboard or using sticky tape to hold the tickets in place on the dashboard. While placard holders and sticky tape are useful in holding documents in place on the dashboard, they clutter the dashboard. They also can make it difficult for parking attendants to view the documents if the documents are far away from the windshield. Furthermore, the use of sticky tape and placard holders can take time. The use of sticky tape requires that a person has sticky tape on hand and has the time to tape a parking stub to the dashboard. Placard holders require a person to take the placard holder, insert the parking stub or permit into the placard holder, and replace the placard holder onto the dashboard with the parking stub or permit visible through the windshield. The ability to eliminate the need to take time to properly display documents in a windshield without cluttering up the dashboard is desirable.

### SUMMARY OF THE INVENTION

In a first aspect, a sleeve for holding and display a document is provided. The sleeve comprises: a back wall having a top, two opposing sides and a bottom; two side walls, each side wall attached at a first end to one of the sides of the back wall; and a bottom wall attached at a first end of the bottom wall to the bottom of the back wall, wherein when second sides of the side walls and a second side of the bottom wall are positioned flush against a glass surface, the back wall, side walls, bottom wall, and the glass surface form an open-topped receptacle suitable for receiving documents.

In a second aspect, a method of displaying document in a window of a vehicle is provided. The method comprises: providing a sleeve having: a back wall with a top, two opposing sides and a bottom; two side walls, each side wall attached at a first end to one of the sides of the back wall; and a bottom wall attached at a first end of the bottom wall to the bottom of the back wall; attaching the sleeve to the window by attaching a second side of each of the two side walls to the window and a second side of the bottom wall to the window to form an opening between the window and the top of the back wall and a receptacle formed by the back wall, two side walls and the bottom wall; and inserting a document into the sleeve through the opening and between the back wall and the window.

In another aspect, a display sleeve is made of a molded material having a back wall, two side walls attached to opposite ends of the back wall, and a bottom wall attached to both the back wall and the side walls, the material being molded such that when the side walls and the bottom wall are positioned flush against a windshield or other vehicle window, the back wall, side walls, bottom wall, and the windshield form an open-top receptacle suitable for receiving documents such as parking receipts, stubs, and the like.

The display sleeve is attached to the inside of a vehicle windshield or other vehicle window. A user can position the display sleeve with the side walls and bottom wall against the windshield on the interior of the vehicle. The user can then affix the display sleeve to the windshield. In one embodiment, flanges are conveniently provided attached to the bottom wall or side walls that allow for attachment to the windshield. In certain embodiments, the display sleeve may have a fixed or releasable fastener on the flanges or along the outer periphery of the portions of the side walls and bottom wall lying substantially flush against the windshield on the interior of the vehicle. Where there is no fastener provided on the display sleeve, a user can glue the display sleeve to the windshield. In the case of releasable fasteners that require mating members, a user can apply a first half of a fastener or mating member to the flanges or along the outer periphery of the portions of the side walls and bottom wall lying substantially flush against the windshield on the interior of the vehicle. A variety of fasteners are available for this purpose. In some cases, it may be desirable that the fasteners have the capability to withstand extreme conditions in a car, for example, temperatures from −40 degrees Celsius to 50 degrees Celsius. These fasteners can also be translucent or optically clear for optimal visibility through the windshield and also for aesthetic purposes. Mating members applied to the flanges or along the outer periphery of the portions of the side walls and bottom wall include mating members of hook and loop materials, magnets, adhesives such as sticky tape, mating hook portions, etc. and may be adhesive-backed for attachment. The user can then apply a second half of the fastener or mating member to the interior of the windshield where the display sleeve is to be attached, and can mate the first mating member on the flanges or along the outer periphery of the portions of the side walls and bottom wall with the second mating member applied to the windshield.

The back wall, side walls, and bottom wall of the display sleeve, and the windshield together form a receptacle with an open top. In some embodiments, it may be desirable that the open top is large enough for users to put their fingers in to pull documents out of the receptacle. Alternatively, there may be one or more apertures in the back wall that allow a user to push or pull documents out of the open top. Such apertures may allow wind to enter and blow into the receptacle, disturbing documents in the receptacle, so the exact construction may vary with the conditions. The receptacle is suitable for receiving documents such as parking receipts, stubs, and the like with the necessary information facing the windshield. This allows a user to quickly and easily display their parking receipt or permit by slipping it through the open top into the receptacle. The display sleeve prevents the documents from being displaced when the vehicle door is closed, when the vehicle is in motion, or when a breeze goes through the vehicle. The display sleeve guards the documents from being lost until they are no longer needed and can be discarded, without cluttering the dashboard. The sleeve also keeps loose items and documents out of the way, while keeping important documents organized for use at a later date, for example, keeping passes for multiple parking lots in a single place where they can be easily located and displayed when necessary. Furthermore, the display sleeve is easy to install and allows parking attendants or officers to quickly spot and easily view the necessary information on the documents, without any obstructions, through the windshield.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a front view of a display sleeve in an aspect of the invention;

FIG. 2 is a perspective view of the display sleeve shown in FIG. 1;

FIG. 3 is a schematic illustration of the sleeve display shown in FIG. 1 in use on a windshield of a vehicle with documents inserted into it;

FIG. 4 is a top sectional view of a windshield showing an installation method of display sleeve of FIG. 1;

FIG. 5 is a front perspective view of a display sleeve without flanges;

FIG. 6 is a top sectional view of a windshield with the display sleeve of FIG. 5 attached;

FIG. 7 is a front view of a display sleeve with apertures in the back wall; and

FIG. 8 is a perspective view of the display sleeve shown in FIG. 7.

### DETAILED DESCRIPTION OF THE ILLUSTRATED EMBODIMENTS

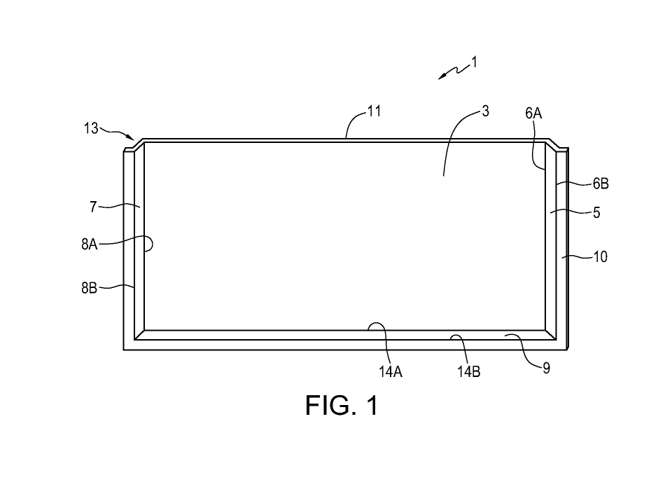

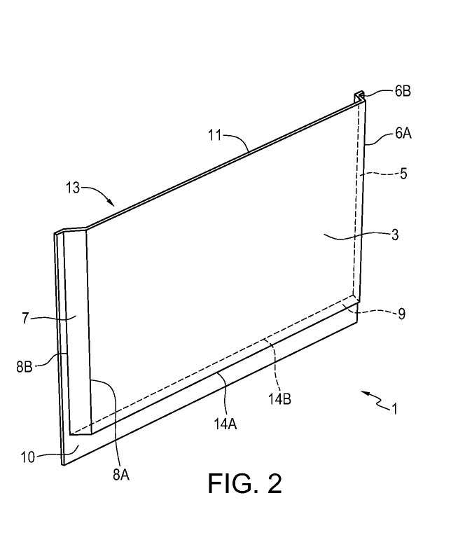

FIGS. 1 and 2 illustrate a display sleeve 1 for receiving, holding, and displaying documents. Display sleeve 1 is defined by a back wall 3, a first side wall 5 attached to the back wall 3, a second side wall 7 attached to the back wall 3 on the opposite side of the first wall 5, and a bottom wall 9 attached to the side walls 5 and 7 and the back wall 3. The first side wall 5 can a have a first side 6A connected to the back wall 3 and a second side 6B extending away from the back wall 3. The second side wall 7 can have a first side 8A connected to the back wall 3 and a second side 8B extending away from the back wall 3. The bottom wall 9 can have first side 14A connected to the back wall 3 and a second side 14B extending away from the back wall 3.

The illustrated display sleeve 1 can be provided with a flange 10 on a portion of the periphery of display sleeve 1 of sufficient size for use in affixing display sleeve 1 to a vehicle windshield. In one aspect, the flange 10 can be connected to the second side 6B of the first side wall 5, the second side 8B of the second side wall 7 and the second side 14B of the bottom wall 9.

Display sleeve 1 defines a receptacle 11 with an open top 13 between the back wall 3, side walls 5 and 7, and bottom wall 9 when placed against a windshield (not shown) of suitable dimension for receiving a document such as a parking stubs. receipts, or other documents. Receptacle 11 comprises an open area or window framed by the side walls 5 and 7 and bottom wall 9, and which allows a passerby to view documents placed in the receptacle 11 through a windshield (not shown). An open top 13 of the receptacle 11 provides access to the receptacle 11 so that parking stubs and other documents can slide into or out of the receptacle 11 easily.

Display sleeve 1 can have any suitable size, geometry, shape, and design. Display sleeve 1 can be constructed from a variety of flexible or durable materials, including plastic, wood, metals, etc. In one embodiment, the display sleeve 1 is made of rigid translucent plastic. The material of display sleeve 1 may be varied and selected suitably depending on what is most esthetically pleasing and suitable for its purpose. Display sleeve 1 can be made using various methods, including molding or can be made in one piece by combining several pieces together. The open area or window can be created during the molding process or can be cut into the display sleeve 1 material after the molding has been complete. Other structures or methods will be apparent to one skilled in the art.

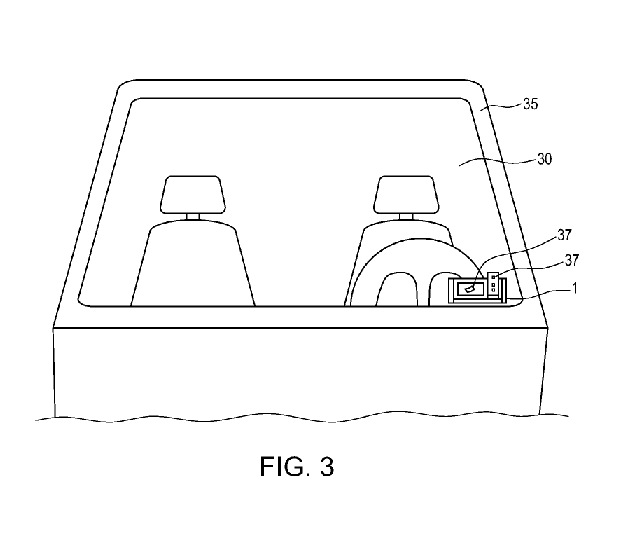

FIG. 3 illustrates the display sleeve 1 in use. The display sleeve 1 is affixed to the front windshield 30 on the interior of a vehicle 35, preferably in a position that would not obstruct one's vision when driving. Display sleeve 1 can be oriented such that the back wall 3 is opposite the windshield 30 and the open top 13 is facing upward. In this way, documents 37 such as parking stubs can be slipped into the display sleeve 1 through the open top 13 and can be situated in the receptacle 11 formed between the back wall 3, side walls 5 and 7, bottom wall 9, and windshield 30 with the necessary information facing the front windshield 30 such that they are easily viewable to parking attendants, officers and other people passing by through the windshield.

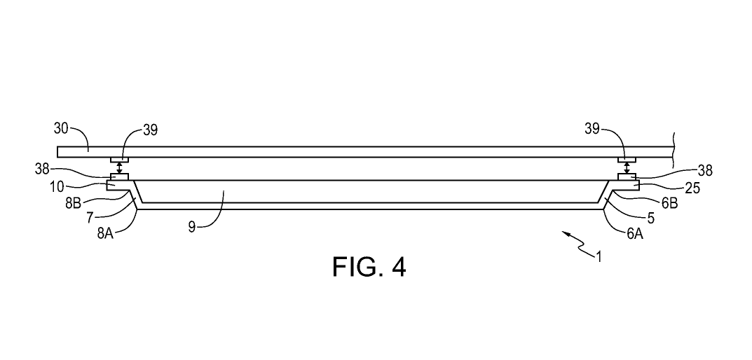

FIG. 4 illustrates a method of installing the display sleeve 1. To install the display sleeve 1, a vehicle windshield 30 is provided. A user can position the display sleeve 1 with the side walls 5 and 7 and bottom wall 9 against the windshield 30 on the interior of the vehicle. The user can then affix the display sleeve 1 to the windshield 30. In one embodiment, flanges 10 are conveniently provided attached to the bottom wall 9 or side walls 5 and 7 that allow for attachment to the windshield 30. In certain embodiments, the display sleeve 1 may have a fixed or releasable fastener on the flanges 10 or along the outer periphery 25 of the portions of the side walls 5 and 7 and bottom wall 9 lying substantially flush against the windshield on the interior of the vehicle 35. Where there is no fastener provided on the display sleeve 1, a user can glue the display sleeve 1 to the windshield 30. In the case of releasable fasteners that require mating members, a user can apply a first half of a fastener 38 or mating member to the flanges 10 or along the outer periphery 25 of the portions of the side walls 5 and 7 and bottom wall 9 lying substantially flush against the windshield 30 on the interior of the vehicle 35. A variety of fasteners are available for this purpose. In some embodiments, it may be desirable that these fasteners are able to withstand extreme conditions in a car from −40 degrees Celsius to 50 degrees Celsius. These fasteners can also be translucent or optically clear for optimal visibility through the windshield and also for aesthetic purposes. Mating members 38 applied to the flanges 10 or along the outer periphery 25 of the portions of the side walls 5 and 7 and bottom wall 9 include first half of mating members of hook and loop materials, magnets, adhesives such as sticky tape, mating hook portions, etc. and may be adhesive-backed for attachment. The user can then apply a second half of the fastener 39 or mating member to the interior of the windshield 30 where the display sleeve 1 is to be attached, and can mate the first mating member 38 on the flanges 10 or along the outer periphery 25 of the portions of the side walls 5 and 7 and bottom wall 9 with the second mating member 39 applied to the windshield 30. The back wall 3, side walls 5 and 7, and bottom wall 9 of the display sleeve 1, and the windshield 30 together form a receptacle 11 with an open top 13, which in one embodiment, is large enough for users to put their fingers in to pull documents 37 out of the receptacle 11.

The display sleeve 1 prevents the documents 37 from being displaced when the vehicle door is closed, when the vehicle is in motion, or when a breeze goes through the vehicle. When the documents 37 are no longer needed, the user can put their fingers through the open top 13 to remove the documents 37 from the receptacle 11, and can reuse the display sleeve 1 for any further documents 37 to be displayed.

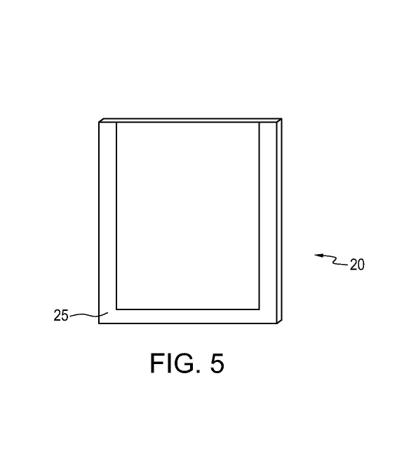

FIG. 5 illustrates a display sleeve 20 that is not molded to form a flange on a portion of the periphery 25 of the display sleeve 20, though the periphery 25 of the display sleeve 20 is able to be used to affix display sleeve 20 to a vehicle windshield, in any case.

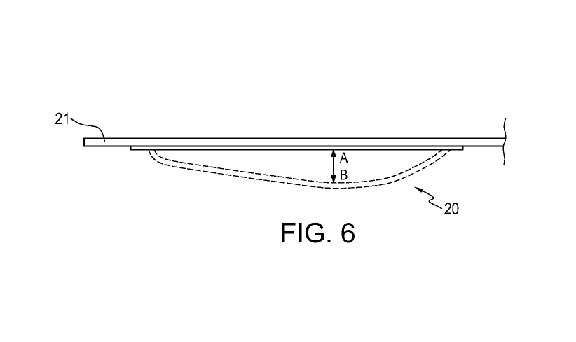

FIG. 6 illustrates a sectional top view of a windshield 21 and the display sleeve 20 shown in FIG. 5. In the embodiment illustrated in FIG. 5 and FIG. 6, display sleeve 20 is made of a resilient plastic that deforms upon insertion of a parking stub or permit and resiliently applies force to the stub or permit to securely hold it in place. Display sleeve 20 is positioned flush against the windshield 21 in a rest position at position A, and can be pulled into a stretched position at position B. Upon removal of force to the display sleeve 20, display sleeve 20 returns to rest position A.

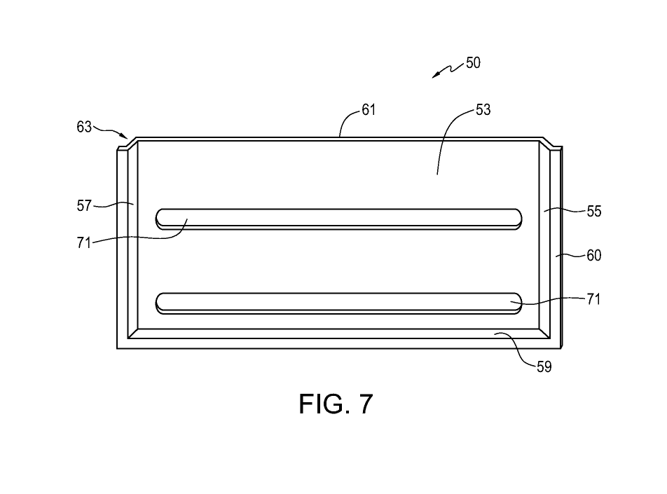

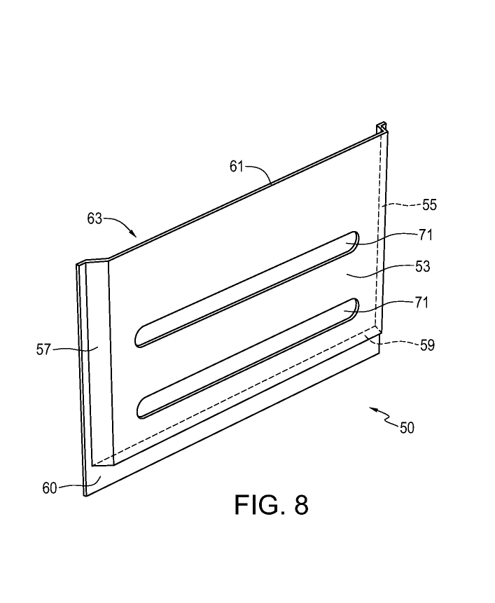

FIG. 7 and FIG. 8 illustrate an alternate embodiment of a display sleeve 50 of the present invention. Display sleeve 50 is similar in construction to the embodiment shown in FIGS. 1 and 2, having a back wall 53, a first side wall 55 attached to the back wall 53, a second side wall 57 attached to the back wall 53 on the opposite side of the first wall 55, and a bottom wall 59 attached to the side walls 55 and 57 and the back wall 53. The illustrated display sleeve 50 can also be provided with a flange 60 on a portion of the periphery of display sleeve 50 of sufficient size for use in affixing display sleeve 50 to a vehicle windshield.

In this alternate embodiment illustrated in FIG. 7 and FIG. 8, there may be apertures 71 in the back wall 53 that allow a user to push or pull documents or slips out of an open top 63. Such apertures 71 may allow wind to enter and blow into a receptacle 61, disturbing documents in the receptacle 61, so the exact construction may vary with the conditions. A receptacle 61 is similar in construction to the receptacle shown in FIGS. 1 and 2 and is suitable for receiving documents such as parking receipts, stubs, and the like with the necessary information facing outwardly toward the windshield. This allows a user to quickly and easily display their documents such as a parking receipt or permit by slipping it through the open top 63 into the receptacle 51. When the documents are no longer needed and it is desired to remove the documents from the receptacle 51, the user can put their fingers through the apertures 71 in the back wall 53 and into the receptacle 51 to force the old documents upward out of the open top 63. The user can then reuse the display sleeve 50 for any further documents to be displayed.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

1. A sleeve for holding and display a document, the sleeve comprising:
a back wall having a top, two opposing sides and a bottom;
two side walls, each side wall attached at a first end to one of the sides of the back wall; and
a bottom wall attached at a first end of the bottom wall to the bottom of the back wall,
wherein when second sides of the side walls and a second side of the bottom wall are positioned flush against a glass surface, the back wall, side walls, bottom wall, and the glass surface form an open-topped receptacle suitable for receiving documents.

2. The sleeve of claim 1 further comprising a flange connected to at least a portion of a periphery of the sleeve.

3. The sleeve of claim 2 wherein a fastener is provided on the flange.

4. The sleeve of claim 3 wherein the fastener is at least one of: a hook and loop material; a magnet; and an adhesive.

5. The sleeve of claim 2 wherein the flange is connected to the second sides of the side walls and the second side of the bottom wall.

6. The sleeve of claim 1 wherein the sleeve is formed of translucent plastic.

7. The sleeve of claim 1 wherein the back wall is formed of a resilient plastic.

8. The sleeve of claim 1 further comprising at least one aperture passing through the back wall.

9. A method of displaying document in a window of a vehicle, the method comprising:
providing a sleeve having:
a back wall with a top, two opposing sides and a bottom;
two side walls, each side wall attached at a first end to one of the sides of the back wall; and
a bottom wall attached at a first end of the bottom wall to the bottom of the back wall;
attaching the sleeve to the window by attaching a second side of each of the two side walls to the window and a second side of the bottom wall to the window to form an opening between the window and the top of the back wall and a receptacle formed by the back wall, two side walls and the bottom wall; and
inserting a document into the sleeve through the opening and into the receptacle.

10. The method of claim 9 wherein the document has information provided on one side of the document and the document is inserted into the receptacle so that the information is facing the window.

11. The method of claim 9 further comprising providing a flange connected to at least a portion of a periphery of the sleeve and wherein the sleeve is attached to window by attaching the flange to the window.

12. The method of claim 9 wherein the sleeve is attached to the window by at least one fastener.

13. The method of claim 12 wherein the at least one fastener is at least one of: a hook and loop material; a magnet; and an adhesive.

14. The method of claim 9 wherein the back wall is formed of a resilient plastic and the document is inserted between the back wall of the sleeve and the window by stretching the back wall away from the window, inserting the document between the back wall and the window and then allowing the back wall to retract back towards the window.

15. The method of claim 9 further comprising providing at least one aperture in the back wall of the sleeve and removing the document from receptacle by inserting a finger through the at least one aperture and using the finger to slide the document upwards through the opening.

16. The method of claim 19 wherein the sleeve is attached to the window providing at least one first half of a mating member to the sleeve and attaching at least one second half of a mating member to the window, then attaching the at least one first half of the mating member to the at least one second half of the mating member.

17. A sleeve for holding and display a document, the sleeve comprising:
a back wall formed of a resilient material; and
a periphery for attaching to a window of a vehicle.
